(19) United States
(12) Patent Application Publication
(10) Pub. No.: US 2026/0023280 A1
(43) Pub. Date: Jan. 22, 2026

(54) METHOD OF MANUFACTURING DISPLAY DEVICE AND DISPLAY DEVICE

(71) Applicant: Japan Display Inc., Tokyo (JP)

(72) Inventor: Junko NAGASAWA, Tokyo (JP)

(21) Appl. No.: 19/274,725

(22) Filed: Jul. 21, 2025

(30) Foreign Application Priority Data
Jul. 22, 2024 (JP) 2024-116887

(51) Int. Cl. G02F 1/1335; G02F 1/1333; G02F 1/1334

(52) U.S. Cl. CPC G02F 1/133502; G02F 1/133368; G02F 1/1334

(57) ABSTRACT

According to one embodiment, a method of manufacturing a display device includes placing a transparent substrate having a first main surface, placing a transparent material above the first main surface, forming a transparent layer, in which at least a part of the first main surface is exposed, by patterning the transparent material thus placed, placing a low-refractive-index material on the first main surface and the transparent layer, and forming a low-refractive index layer to which the transparent layer is exposed, by patterning the low-refractive index material thus placed. The transparent layer has an oil repellency higher than that of the first main surface with respect to the low-refractive index layer.

### CROSS-REFERENCE TO RELATED APPLICATIONS

This application is based upon and claims the benefit of priority from Japanese Patent Application No. 2024-116887, filed Jul. 22, 2024, the entire contents of which are incorporated herein by reference.

### FIELD

Embodiments described herein relate generally to a method of manufacturing a display device and a display device.

### BACKGROUND

In recent years, display devices comprising a display panel having a polymer dispersed liquid crystal (PDLC) layer, a light source and the like have been proposed. The polymer dispersed liquid crystal layer can switch between a scattering state, in which light is scattered, and a transparent state, in which light is transmitted.

The display device can display images in the scattering state. When the display panel is switched to the transparent state, the user can visually recognize the background through the display panel.

### BRIEF DESCRIPTION OF THE DRAWINGS

FIG. 1 is a diagram showing a configuration example of a display device according to the first embodiment.

FIG. 2 is a cross-sectional view schematically showing the configuration example of the display device shown in FIG. 1.

FIG. 3 is an exploded perspective view showing main parts of the display device according to the first embodiment.

FIG. 4 is a plan view schematically showing the display device shown in FIG. 3.

FIG. 5 is a schematic cross-sectional view taken along the line V-V shown in FIG. 4.

FIG. 6 is a schematic cross-sectional view taken along the line VI-VI shown in FIG. 4.

FIG. 7 is a diagram illustrating a method of manufacturing the display device according to the first embodiment.

FIG. 8 is another diagram illustrating the method of manufacturing the display device according to the first embodiment.

FIG. 9 is still another diagram illustrating the method of manufacturing the display device according to the first embodiment.

FIG. 10 is still another diagram illustrating the method of manufacturing the display device according to the first embodiment.

FIG. 11 is still another diagram illustrating the method of manufacturing the display device according to the first embodiment.

FIG. 12 is a diagram illustrating a method of manufacturing a display device according to a comparative example.

FIG. 13 is a cross-sectional view schematically showing a display device according to the second embodiment.

FIG. 14 is a cross-sectional view schematically showing a display device according to the third embodiment.

FIG. 15 is a schematic cross-sectional view of the display device according to the third embodiment.

FIG. 16 is a diagram illustrating a method of manufacturing the display device according to the third embodiment.

FIG. 17 is another diagram illustrating the method of manufacturing the display device according to the third embodiment.

FIG. 18 is still another diagram illustrating the method of manufacturing the display device according to the third embodiment.

FIG. 19 is still another diagram illustrating the method of manufacturing the display device according to the third embodiment.

FIG. 20 is still another diagram illustrating the method of manufacturing the display device according to the third embodiment.

FIG. 21 is a cross-sectional view schematically showing a display device according to the fourth embodiment.

### DETAILED DESCRIPTION

In general, a manufacturing method for a display device according to one embodiment is a method of manufacturing a display device which has a liquid crystal layer containing a polymer-dispersed liquid crystal and which can switch between a state in which light entering the liquid crystal layer is transmitted and a state in which the light is scattered according to an applied voltage. The manufacturing method includes: placing a transparent substrate having a first main surface, placing a transparent material above the first main surface, forming a transparent layer, in which at least a part of the first main surface is exposed, by patterning the transparent material thus placed, placing a low-refractive-index material on the first main surface and the transparent layer, and forming a low-refractive index layer to which the transparent layer is exposed, by patterning the low-refractive index material thus placed. The low-refractive index layer has a refractive index lower than that of the transparent substrate. The transparent layer has an oil repellency higher than that of the first main surface with respect to the low-refractive index layer.

According to another embodiment, the method of manufacturing a display device, includes placing a transparent substrate having a second main surface, forming a common electrode having a third main surface on the second main surface, placing a transparent material on the third main surface, forming a transparent layer, in which at least a part of the third main surface is exposed, by patterning the transparent material thus placed, placing a low-refractive-index material on the third main surface and the transparent layer, and forming a low-refractive index layer to which the transparent layer is exposed, by patterning the low-refractive index material thus placed. The low-refractive index layer has a refractive index lower than that of the transparent substrate. The transparent layer has an oil-repellency higher than that of the third main surface with respect to the low-refractive index layer.

Further, according to still another embodiment, a display device comprises a first transparent substrate, a second transparent substrate, a liquid crystal layer containing a polymer-dispersed liquid crystal and disposed between the first transparent substrate and the second transparent substrate, and a low-refractive index layer disposed between the liquid crystal layer and the second transparent substrate and having a refractive index lower than that of the second transparent substrate. The low-refractive index layer has a bottom portion located on a side of the second transparent substrate and an upper portion having a width greater than that of the bottom portion.

With configurations such as described above, it is possible to provide a method of manufacturing a display device and such a display device, which can suppress the decrease in reliability.

Each of the embodiments will now be described hereinafter with reference to the accompanying drawings. Note that the disclosure is merely an example, and proper changes within the spirit of the invention, which are easily conceivable by a skilled person, are included in the scope of the invention as a matter of course.

In addition, as to the drawings, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

Note that, in order to make the descriptions more easily understandable, some of the drawings illustrate an X axis, a Y axis and a Z axis orthogonal to each other. A direction along the X axis is referred to as a first direction X, a direction along the Y axis is referred to as a second direction Y and a direction along the Z axis is referred to as a third direction Z. Further, viewing the constitutional elements parallel to the Z direction is referred to as plan view.

In each of the embodiments, as an example of the display device, a highly light-transmitting transparent display device in which using polymer-dispersed liquid crystals are applied (, which is the so-called transparent display device) is disclosed. Note that the configurations disclosed in each embodiment may be applied to other types of display devices as well.

### First Embodiment

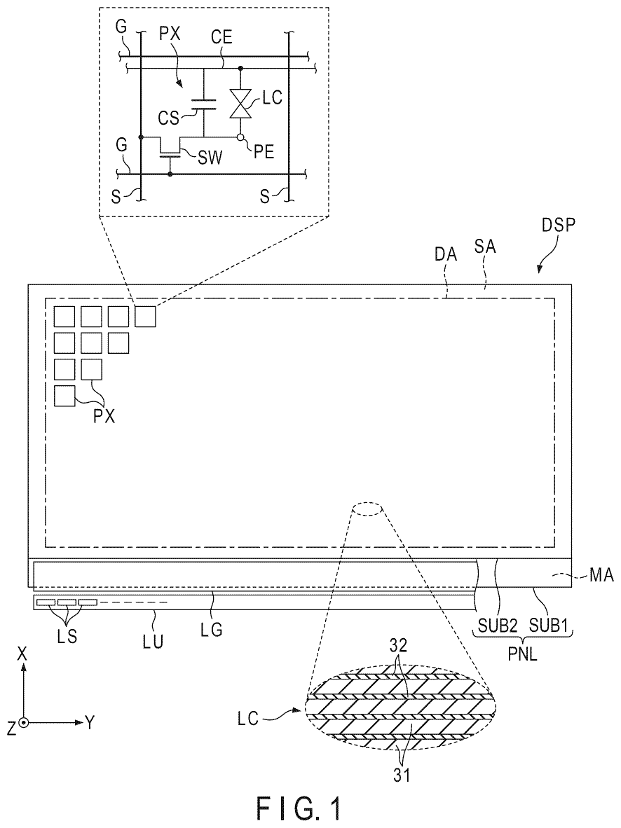

FIG. 1 is a diagram showing a configuration example of a display device DSP according to this embodiment. The display device DSP comprises a display panel PNL, a light source unit LU, and a light guide LG. In the example shown in FIG. 1, the light source unit LU and the light guide LG are indicated by broken lines, and are partly omitted.

The display panel PNL comprises a first substrate SUB1 and a second substrate SUB2 overlaid in the third direction Z. In the example shown in FIG. 1, the first substrate SUB1 and the second substrate SUB2 have rectangular shapes in plan view, in which long sides thereof are parallel to the second direction Y. Note that the shapes of the first substrate SUB1 and the second substrate SUB2 are not limited to those of this example, and may as well, for example, be rectangular with long sides parallel to the first direction X, or circular, elliptical, or the like.

The length of the first substrate SUB1 along the first direction X is greater than the length of the second substrate SUB2 along the first direction X. The first substrate SUB1 has a mount area MA formed in a portion protruding from the second substrate SUB2 in a direction opposite to the first direction X. The mount area MA corresponds to a region of the first substrate SUB1, which does not overlap the second substrate SUB2. In the mount area MA, integrated circuits or flexible circuit boards (not shown) are mounted.

The display panel PNL includes a display area DA which displays images and a frame-like peripheral area SA which surrounds the display area DA. The display area DA and the peripheral area SA are both formed in the portion where the first substrate SUB1 and the second substrate SUB2 overlap each other. The display area DA comprises a plurality of pixels PX arranged in a matrix pattern along the first direction X and the second direction Y.

The display panel PNL further comprises a liquid crystal layer LC sealed between the first substrate SUB1 and the second substrate SUB2. As shown schematically in an enlarged view at a lower portion of FIG. 1, the liquid crystal layer LC is constituted by a polymer dispersed liquid crystal containing polymers 31 and liquid crystal molecules 32.

In one example, the polymers 31 are liquid crystal polymers. The polymers 31 are formed into filaments extending along the second direction Y and aligned along the first direction X. The liquid crystal molecules 32 are dispersed in the gaps between the polymers 31 such that their longitudinal axes are aligned along the second direction Y.

Both the polymers 31 and liquid crystal molecules 32 exhibit optical anisotropy or refractive index anisotropy. The response of the polymers 31 to an electric field is lower than that of the liquid crystal molecules 32 to an electric field. In one example, the alignment direction of the polymers 31 remains substantially unchanged regardless of the presence or absence of an electric field. In contrast, the alignment direction of the liquid crystal molecules 32 changes according to the voltage applied to the liquid crystal layer LC.

When no voltage is being applied to the liquid crystal layer LC, the optical axes of the polymers 31 and the liquid crystal molecules 32 are parallel to each other, and light entering the liquid crystal layer LC passes through the liquid crystal layer LC without substantially scattering therein (transparent state).

When a voltage is being applied to the liquid crystal layer LC, the optical axes of the polymers 31 and the liquid crystal molecules 32 intersect each other, and light entering the liquid crystal layer LC is scattered therewithin (scattering state). That is, the display device DSP can switch between the transparent state and the scattering state according to the applied voltage.

As shown enlargedly in an upper part of FIG. 1, the display area DA includes a plurality of scanning lines G and a plurality of signal lines S disposed thereon. These scanning lines G each extend along the second direction Y and are aligned along the first direction X. These signal lines S each extend along the first direction X and are aligned along the second direction Y. The signal lines S intersect the scanning lines G with each other.

Each of the pixels PX comprises a switching element SW, a pixel electrode PE, a common electrode CE, and a capacitor CS. The switching element SW is constituted, for example, by a thin film transistor (TFT) and connected to a scanning line G and a respective signal line S. The pixel electrode PE is electrically connected to the switching element SW.

The liquid crystal layer LC (in particular, liquid crystal molecules 32) is driven by an electric field generated between the pixel electrode PE and the common electrode CE. The capacitor CS is formed between an electrode having the same potential as that of the common electrode CE and an electrode having the same potential as that of the pixel electrode PE.

The light source unit LU and the light guide LG are disposed along the mount area MA. The light source unit LU comprises a plurality of light-emitting elements LS aligned along the second direction Y. Each of the light-emitting elements LS irradiates light onto the light guide LG. As the light guide LG, for example, a lens such as a prism lens may be used.

For example, the plurality of light-emitting elements LS include light-emitting elements that emit red light, light-emitting elements that emit green light, and light-emitting elements that emit blue light. These light-emitting elements may be aligned along the second direction Y or stacked along the third direction Z. As the light-emitting elements LS, light-emitting diodes (LEDs) can be used.

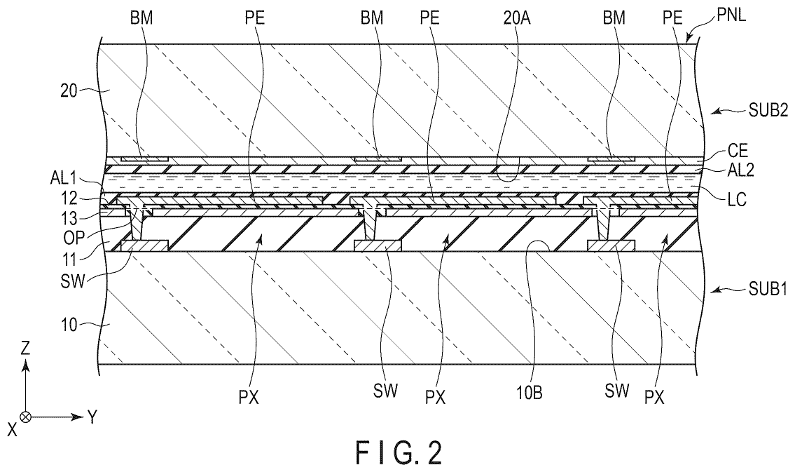

FIG. 2 is a cross-sectional view schematically showing a configuration example of the display panel PNL shown in FIG. 1. The first substrate SUB1 comprises a transparent substrate 10 (first transparent substrate), insulating films 11 and 12, capacitive electrodes 13, switching elements SW, pixel electrodes PE, and an alignment film AL1.

Although omitted from the illustration, the first substrate SUB1 further includes the scanning lines G and signal lines S shown in FIG. 1. The switching elements SW are disposed on the main surface 10B of the transparent substrate 10. The main surface 10B faces the second substrate SUB2. The insulating film 11 covers the switching elements SW. The capacitive electrodes 13 are located between the insulating film 11 and the insulating film 12.

In the example illustrated, the insulating film 11 and the capacitive electrode 13 are disposed over the entire surface of each pixel PX, but the configuration here is not limited to that of this example. It suffices if the insulating film 11 is disposed to cover at least the switching elements SW, the scanning lines G, and the signal lines S.

The capacitive electrode 13 may be formed into a grid pattern along the scanning lines G and signal lines S. The pixel electrodes PE are disposed on the insulating film 12, one by one for each pixel PX. The pixel electrodes PE are each electrically connected to the respective switching element SW through an aperture OP of the respective capacitive electrode 13. The pixel electrodes PE overlap the capacitive electrodes 13, respectively, while interposing the insulating film 12 therebetween, thus forming the respective capacitors CS of the pixels PX. The alignment film AL1 covers the pixel electrodes PE.

The second substrate SUB2 comprises a transparent substrate 20 (third transparent substrate), light-shielding layers BM, a common electrode CE, and an alignment film AL2. The transparent substrate 20 faces the transparent substrate 10 along the third direction Z. The transparent substrate 20 has a main surface 20A. The main surface 20A faces the transparent substrate 10.

The light-shielding layers BM and the common electrode CE are disposed on the main surface 20A of the transparent substrate 20. The light-shielding layers BM are located, for example, directly above the switching elements SW, and directly above the scanning lines G, and the signal lines S (not shown), respectively.

The common electrode CE faces the pixel electrodes PE along the third direction Z, while interposing the liquid crystal layer LC therebetween. The common electrode CE is provided over multiple pixels PX and directly covers the light-shielding layer BM. The common electrode CE is electrically connected to the capacitor electrode 13 and is at the same potential as that of the capacitor electrodes 13. The alignment film AL2 covers the common electrode CE.

The liquid crystal layer LC is located between the transparent substrate 10 and the transparent substrate 20 and is in contact with the alignment films AL1 and AL2. In the first substrate SUB1, the insulating film 11, insulating film 12, capacitive electrodes 13, switching elements SW, pixel electrodes PE, alignment film AL1, scanning lines G, and signal lines S are located between the transparent substrate 10 and the liquid crystal layer LC. In the second substrate SUB2, the light-shielding layer BM, common electrode CE, and alignment film AL2 are located between the transparent substrate 20 and the liquid crystal layer LC.

The transparent substrates 10 and 20 are insulating substrates such as glass substrates or plastic substrates. The insulating film 11 is formed from a transparent insulating material such as silicon oxide, silicon nitride, silicon oxynitride, or acrylic resin.

In one example, the insulating film 11 includes an inorganic insulating film and an organic insulating film. The insulating film 12 is an inorganic insulating film such as of silicon nitride. The capacitive electrodes 13, pixel electrodes PE, and common electrode CE are transparent electrodes each formed from a transparent conductive material such as indium tin oxide (ITO) or indium zinc oxide (IZO). The light-shielding layers BM are each a conductive layer having a resistance lower than that of the common electrode CE.

In one example, the light-shielding layers BM are each formed from an opaque metal material such as molybdenum, aluminum, tungsten, titanium, or silver. The alignment films AL1 and AL2 are each a horizontal alignment film having an alignment restriction force substantially parallel to the X-Y plane. In one example, the alignment films AL1 and AL2 are subjected to alignment treatment along the second direction Y. Note that the alignment treatment may be a rubbing treatment or a photo-alignment treatment.

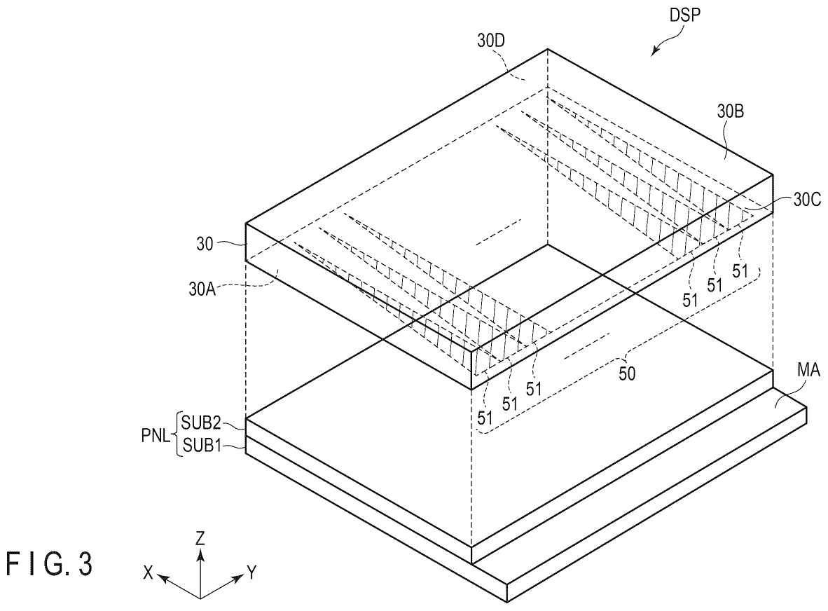

FIG. 3 is an exploded perspective view showing the main parts of the display device DSP according to this embodiment. The display device DSP further comprises a transparent substrate 30 (second transparent substrate) as shown in FIG. 3. The transparent substrate 30 is formed into a flat plate shape.

The transparent substrate 30 is, for example, a glass substrate, but may as well be an insulating substrate such as a plastic substrate. The size of the transparent substrate 30 in plan view is equivalent to the size of the second substrate SUB2 in plan view.

The transparent substrate 30 has a main surface 30A, a main surface 30B located on an opposite side to the main surface 30A, and side surfaces 30C and 30D connecting the main surface 30A and main surface 30B to each other. In this embodiment, the main surface 30A is an example of the first main surface.

The main surfaces 30A and 30B are surfaces parallel to the X-Y plane defined by the X-axis and the Y-axis. The main surface 30A faces the transparent substrate 20 of the second substrate SUB2. The side surfaces 30C and 30D are parallel to the Y-Z plane defined by the Y-axis and the Z-axis. The side surface 30C and side surface 30D are aligned in this order along the first direction X.

The thickness of the transparent substrate 30 is greater than the thickness of the first substrate SUB1 and the second substrate SUB2. Here, the thickness is defined as the distance along the third direction Z. In one example, the transparent substrate 30 has a thickness that is twice or more greater than that of the first substrate SUB1 and the second substrate SUB2.

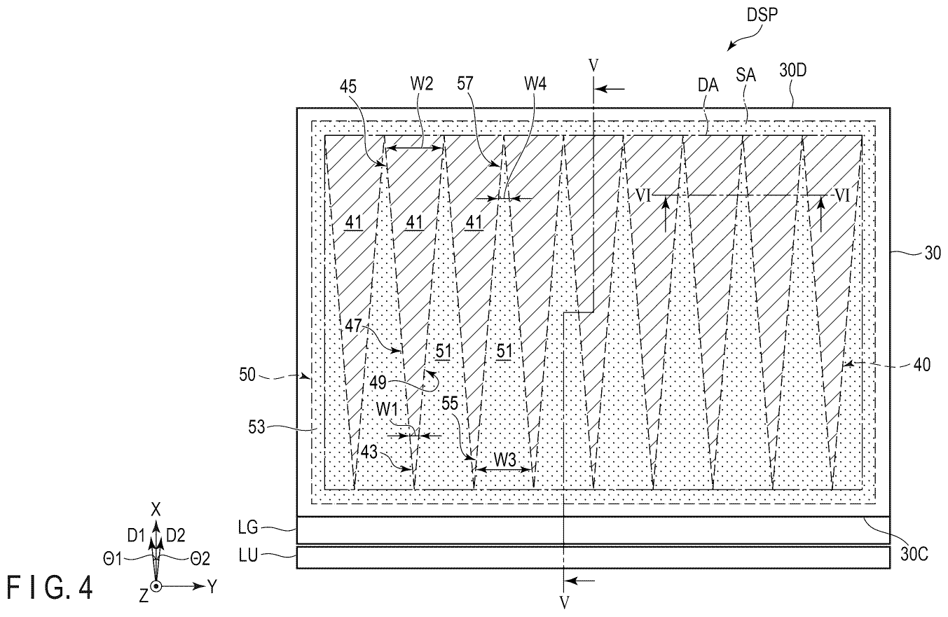

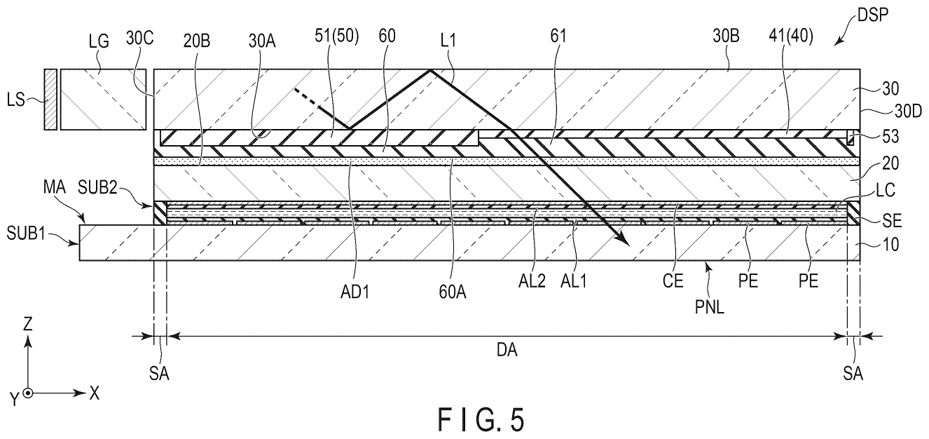

FIG. 4 is a schematic plan view of the display device DSP shown in FIG. 3. FIG. 5 is a schematic cross-sectional view taken along the line V-V shown in FIG. 4. In each of these figures, the structures such as the display panel PNL are shown schematically, and some elements are omitted.

As shown in FIG. 5, the liquid crystal layer LC is disposed between the transparent substrate 10 of the first substrate SUB1 and the transparent substrate 30, and the transparent substrate 20 of the second substrate SUB2 is disposed between the liquid crystal layer LC and the transparent substrate 30.

The display device DSP further includes, as shown in FIGS. 4 and 5, a transparent layer 40, a low-refractive index layer 50, and a protective layer 60. In FIG. 4, the transparent layer 40 is marked with diagonal lines, and the low-refractive index layer 50 is marked with dots. In this embodiment, the transparent substrate 30, transparent layer 40, low-refractive index layer 50, and protective layer 60 constitute a light guide for illuminating the display panel PNL.

The transparent layer 40 has, for example, oil-repellent properties. The transparent layer 40 is formed, for example, from a fluorine-based resin material or a silicon-based resin material.

Additionally, the transparent layer 40 may as well be formed from an acrylic-based resin material, which is a negative-type photosensitive resin, or a phenol-based resin material, which is a positive-type photosensitive resin.

The transparent layer 40 is disposed on the main surface 30A of the transparent substrate 30, as shown in FIG. 5. The transparent layer 40 overlaps the display area DA. The transparent layer 40 is disposed between the display panel PNL and the transparent substrate 30, as shown in FIG. 5.

The transparent layer 40 has a plurality of strip-like portions 41, as shown in FIG. 4. These strip-like portions 41 each extend along the first direction X and are aligned along the second direction Y. Each adjacent pair of strip-like portions 41 may be connected to or separated from each other.

These strip-like portions 41 have shapes similar to each other. The strip-like portions 41 have, for example, a triangular shape in plan view. Each of the strip-like portions 41 includes a first end portion 43 on a side of the side surface 30C, a second end portion 45 located on an opposite side to the first end portion 43, a first edge 47, and a second edge 49. Here, each of the end portions includes its edge and its surrounding region.

The first edge 47 and the second edge 49 extend in directions different from the first direction X and the second direction Y. For example, the direction that intersects the first direction X at an acute angle in a counterclockwise direction is defined as a direction D1, and the direction that intersects the first direction X at an acute angle in a clockwise direction is defined as a direction D2.

Note that an angle θ1 made between the first direction X and the direction D1, and an angle θ2 made between the first direction X and the direction D2 are, for example, the same as each other, but the configuration is not limited to that of this example, and the angle between the first direction X and the direction D1 may be different from the angle between the first direction X and the direction D2.

The first edge 47 extends along the direction D1, and the second edge 49 extends along the direction D2. The length of the first edge 47 is, for example, equal to the length of the second edge 49. In the example shown in FIG. 4, the first edge 47 and the second edge 49 each extend linearly, but they may be formed as curved lines.

As described above, the strip-like portion 41 has such a width that increases at a constant ratio or an arbitrary ratio as the location moves from the first end portion 43 toward the second end portion 45 along the first direction X. Here, the width refers to the distance along the second direction Y.

The width of the first end portion 43 along the second direction Y is defined as a width W1, and the width of the second end portion 45 along the second direction Y is defined as a width W2. In the example shown in FIG. 4, the width W1 is less than the width W2 (W1<W2).

The low-refractive index layer 50 is a transparent layer formed, for example, from an organic material such as siloxane resin. The low-refractive index layer 50 is disposed between the liquid crystal layer LC and the transparent substrate 30. Specifically, the low-refractive index layer 50 is disposed on the main surface 30A of the transparent substrate 30, as shown in FIG. 5.

In the example shown in FIG. 4, the low-refractive index layer 50 is located on an inner side of the outer shape of the transparent substrate 30. Note that the low-refractive index layer 50 may as well be formed to have a size equivalent to that of the outer shape of the transparent substrate 30.

The low-refractive index layer 50 includes, as shown in FIG. 4, a plurality of first portions 51 and second portions 53. The first portions 51 and second portions 53 are formed to be integrated as one body. The first portions 51 overlap the display area DA, and the second portions 53 overlap the peripheral area SA.

The first portions 51 are each disposed between each respective pair of strip-like portions 41 adjacent to each other along the second direction Y. The first portions 51 each have, for example, a triangular shape in plan view. Further, the second portions 53 are each formed into a frame-like shape surrounding the respective first portion 51 and the respective strip-like portion. Note that the portion between each strip-like portion 41 and each respective second portion 53 as well is included in the respective first portion 51.

The first portions 51 each have a third end portion 55 between the first end portions 43 of each respective adjacent pair of strip-like portions 41 and a fourth end portion 57 between the second end portions 45 of each respective adjacent pair of strip-like portions 41. Each of the third end portion 55 is connected to, for example, a portion of the respective second portion 53 on the side of the side surface 30C, and the fourth end portion 57 is connected to, for example, a portion of the second portion 53 on the side of the side surface 30D.

The first portion 51 has such a width that decreases at a constant ratio or an arbitrary ratio along the first direction X from the third end portion 55 toward the fourth end portion 57. The width of the third end portion 55 along the second direction Y is defined as a width W3, and the width of the fourth end portion 57 along the second direction Y is defined as a width W4. The width W3 is greater than the width W4 (W3>W4).

The low-refractive index layer 50 has a thickness greater than that of the strip-like portion 41 of the transparent layer 40 in the example shown in FIG. 5. Note that the thickness of the low-refractive index layer 50 may as well be equal to that of the transparent layer 40.

The protective layer 60 is a transparent layer. The protective layer 60 may be formed, for example, from an organic material such as siloxane resin, or from an inorganic material such as silicon oxide or silicon nitride.

The protective layer 60 covers both of the transparent layers 40 and the low-refractive index layers 50 from the display panel PNL side, as shown in FIG. 5. The protective layer 60 surrounds the second portion 53 of the low-refractive index layer 50. In other words, the transparent layer 40 and the low-refractive index layer 50 are not exposed from the protective layer 60. Therefore, the main surface 30A of the transparent substrate 30 as well is not exposed from the protective layer 60.

The protective layer 60 further has a main surface 60A. The main surface 60A is a surface facing the transparent substrate 20. The protective layer 60 has the function of planarizing steps formed by the transparent layer 40 and the low-refractive index layer 50. The main surface 60A is a surface parallel to the X-Y plane, for example.

The adhesive layer AD1 adheres the main surface 20B of the transparent substrate 20 and the main surface 60A of the protective layer 60 to each other. The adhesive layer AD1 is colorless and transparent and is formed, for example, by optical clear adhesive (OCA) or optical clear resin (OCR), but the material is not limited to that of this example.

The display panel PNL further includes a seal SE that adheres the first substrate SUB1 and the second substrate SUB2 to each other, as shown in FIG. 5. The seal SE surrounds the display area DA in a plan view. The liquid crystal layer LC is sealed in the space surrounded by the seal SE. The second portion 53 of the low-refractive index layer 50 overlaps the seal SE in the third direction Z.

When focusing on the low-refractive index layer 50, the display panel PNL, adhesive layer AD1, protective layer 60, low-refractive index layer 50, and transparent substrate 30 are stacked in this order along the third direction Z. When focusing on the transparent layer 40, the display panel PNL, adhesive layer AD1, protective layer 60, transparent layer 40, and transparent substrate 30 are stacked in this order along the third direction Z.

The refractive indices of the transparent substrate 10, transparent substrate 20, transparent substrate 30, transparent layer 40, protective layer 60, and adhesive layer AD1 are equivalent to each other. Note that the expression “equivalent” here refers not only to cases where the difference in refractive indices is zero, but also includes cases where the difference in refractive index is 0.05 or less.

The refractive index of the low-refractive index layer 50 is lower than those of the transparent substrate 10, transparent substrate 20, transparent substrate 30, transparent layer 40, protective layer 60, and adhesive layer AD1. In one example, the refractive indices of the transparent substrate 10, transparent substrate 20, transparent substrate 30, transparent layer 40, protective layer 60, and adhesive layer AD1 are approximately 1.5, and the refractive index of the adhesive layer AD1 is approximately 1.3 to 1.4.

Further, the protective layer 60 is formed from a material having high transmittance. Here, the expression “high transmittance” means, for example, that the light transmittance in a wavelength range of 400 nm or more and 800 nm or less is 98% or higher.

The light-emitting element LS, the light-guide LG, and the transparent substrate 30 are aligned in this order along the first direction X, as shown in FIG. 5. The light-emitting element LS irradiates light toward the side surface 30C, while interposing the light guide LG therebetween. Since the light-emitting element LS and the light guide LG are not disposed to face the side surface 30C, the light irradiated from the light-emitting element LS does not substantially enter the side surface 30C.

Here, with reference to FIG. 5, the light irradiated from the light-emitting element LS will be explained. The light irradiated from the light-emitting element LS is appropriately diffused within the light guide LG, and then enters the transparent substrate 30 from the side surface 30C.

The light having entered the transparent substrate 30 from the side surface 30C reaches the liquid crystal layer LC via the transparent substrate 30. As described above, the refractive index of the low-refractive index layer 50 is lower than that of the transparent substrate 30.

Therefore, of the light having entered the transparent substrate 30, light progressing toward the first portion 51 of the low-refractive index layer 50 from the transparent substrate 30 is reflected at an interface between the transparent substrate 30 and the first portion 51.

Further, the light progressing toward the main surface 30B is reflected at an interface between the main surface 30B of the transparent substrate 30 and the air layer. In the region where the transparent substrate 30 and the first portion 51 overlap each other, light progresses the interior of the transparent substrate 30 while being repeatedly reflected.

Furthermore, the light progressing toward the region where the transparent substrate 30 and the strip-like portion 41 of the transparent layer 40 overlap each other passes through the transparent substrate 30, and enters the display panel PNL via the strip-like portion 41 and the adhesive layer AD1. Here, since the refractive index of the transparent layer 40 is equivalent to that of the transparent substrate 30, the light is not substantially reflected at an interface between the transparent substrate 30 and the strip-like portion 41.

In the transparent substrate 30, the side surface 30C side corresponds to the region close to the light-emitting element LS, and the side surface 30D side corresponds to the region distant from the light-emitting element LS. As described above, the area where the main surface 30A of the transparent substrate 30 is in contact with the first portion 51 of the low-refractive index layer 50 is larger in the region closer to the light-emitting element LS, and smaller in the region farther from the light-emitting element LS.

The region where the main surface 30A and the first portion 51 overlap each other corresponds to the region where light having entered the transparent substrate 30 does not substantially enter the display panel PNL side. The region where the main surface 30A and the strip-like portion 41 of the transparent layer 40 overlap each other corresponds to the region where light having entered the transparent substrate 30 can enter the display panel PNL side.

The light emitted from the light-emitting element LS tends to attenuate as it travels away from the light-emitting element LS. In this embodiment, the entering of light from the light-emitting element LS into the display panel PNL is suppressed in the region close to the light-emitting element LS, whereas the entering of light into the display panel PNL is promoted in the region remote away from the light-emitting element LS. In other words, the light from the light-emitting element LS is guided forward by the transparent layer 40 and the first portion 51 of the low-refractive index layer 50.

With this configuration, the brightness in the display area DA can be made uniform in the first direction X, thereby suppressing the occurrence of non-uniformity in brightness. As a result, it is possible to suppress the deterioration of the display quality in the display device DSP.

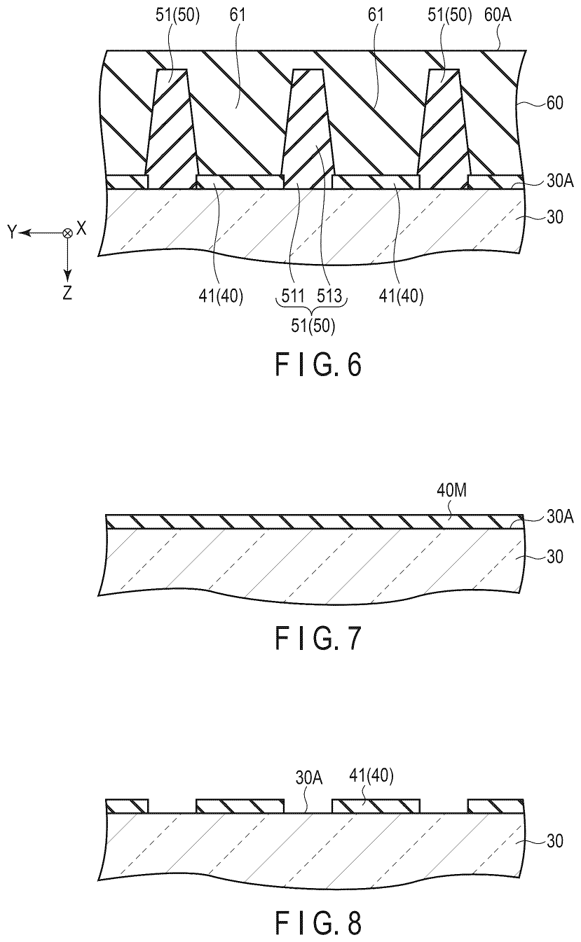

Next, the configuration close to the main surface 30A of the transparent substrate 30 will be described. FIG. 6 is a schematic cross-sectional view taken along the line VI-VI shown in FIG. 4. FIG. 6 shows the transparent substrate 30, the transparent layer 40, the low-refractive index layer 50, and the protective layer 60.

As described above, on the main surface 30A of the transparent substrate 30, the strip-like portions 41 of the transparent layers 40 and the first portions 51 of the low-refractive index layers 50 are disposed. The first portions 51 are each located between each respective adjacent pair of strip-like portions 41.

A part of each low-refractive index layer 50 overlaps the respective transparent layer 40 in the example shown in FIG. 6. The first portion 51 of the low-refractive index layer 50 includes a bottom portion 511 located on a transparent substrate 30 side and an upper portion 513. The bottom portion 511 corresponds to the region overlapping the respective strip-like portion 41 along the second direction Y.

The upper portion 513 has a width greater than that of the bottom portion 511. The upper portion 513 has a portion protruding from the side surfaces of the bottom portion 511. In other words, at one end of the strip-like portion 41, which is on the main surface 30A side of the transparent substrate 30, recesses are made on respective sides. The upper portion 513 has such a width that decreases as it extends in the direction opposite to the third direction Z (distant from the main surface 30A) in the example shown in FIG. 6. The thickness of the upper portion 513 is, for example, greater than the thickness of the bottom portion 511.

The protective layer 60 covers the transparent layers 40 and the low-refractive index layers 50. In other words, the protective layer 60 is in contact with the transparent layers 40 and the low-refractive index layers 50. The protective layer 60 has a thick portion 61 that overlaps the strip-like portions 41 of the transparent layers 40. The thick portion 61 has a thickness greater than that of the region of the protective layer 60, which overlaps the low-refractive index layers 50.

Next, an example of a method of manufacturing the display device DSP will be described.

FIGS. 7 to 11 are diagrams illustrating the method of manufacturing the display device DSP according to this embodiment. FIGS. 7 to 11 each show a respective step in the process by a cross-section parallel to the X-Z plane defined by the first direction X and the third direction Z.

First, a display panel PNL comprising a liquid crystal layer LC, and a transparent substrate 30 having a main surface 30A are fabricated. Next, the transparent substrate 30 is placed as shown in FIG. 7, and a transparent material 40M is placed above the main surface 30A. In one example, the transparent material 40M is directly applied onto the main surface 30A.

Next, as shown in FIG. 8, the transparent material 40M is patterned to form the transparent layer 40. The transparent layer 40 has such a shape as that described with reference to FIGS. 4 to 6. At least a part of the main surface 30A of the transparent substrate 30 is exposed. More specifically, the main surface 30A is exposed between each adjacent pair of the strip-like portions 41 of the transparent layer 40.

The transparent layer 40 is formed into a predetermined shape, for example, by an etching process or a photolithography process. In one example, a resist having a predetermined shape is placed on the transparent material 40M, and the portions exposed from the resist are removed by etching using the resist as a mask. After that, the resist is removed.

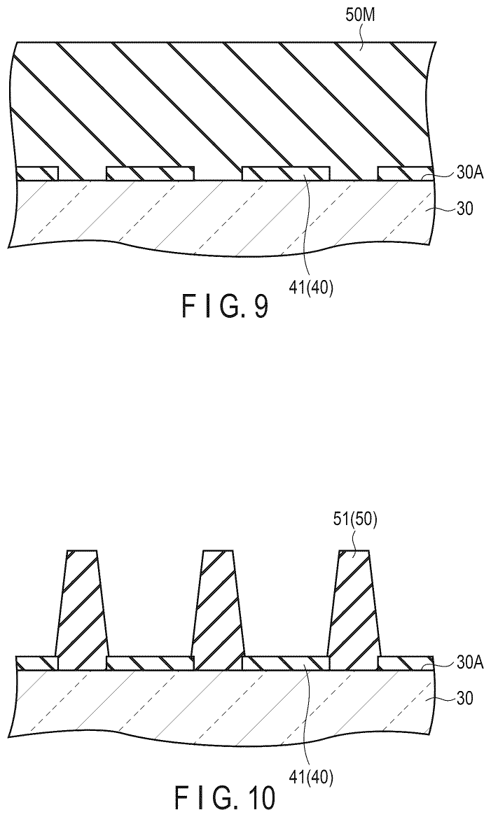

Next, as shown in FIG. 9, a low-refractive-index material 50M is placed on the main surface 30A of the transparent substrate 30 and the transparent layer 40. In one example, the low-refractive-index material 50M is applied onto the main surface 30A and the transparent layer 40.

The low-refractive-index material 50M covers the main surface 30A and the transparent layer 40. The thickness of the low-refractive-index material 50M is greater than the thickness of the transparent layer 40, for example. The low-refractive-index material 50M is in contact with each of the main surface 30A of the transparent substrate 30 and the transparent layer 40. Subsequently, as shown in FIG. 10, the low-refractive index material 50M is by patterned to form a low-refractive index layer 50. The low-refractive index layer 50 is, for example, formed into a film of a predetermined shape by a photolithography process or the like.

The low-refractive index layer 50 has a shape, for example, as described with reference to FIGS. 4 to 6. In the region of the low-refractive index material 50M, which overlaps the transparent layer 40, most of the low-refractive index material 50M is removed (peeled off). In other words, the transparent layer 40 is exposed between each adjacent pair of first portions 51. The exposed portions correspond respectively to the strip-like portions 41 of the transparent layer 40.

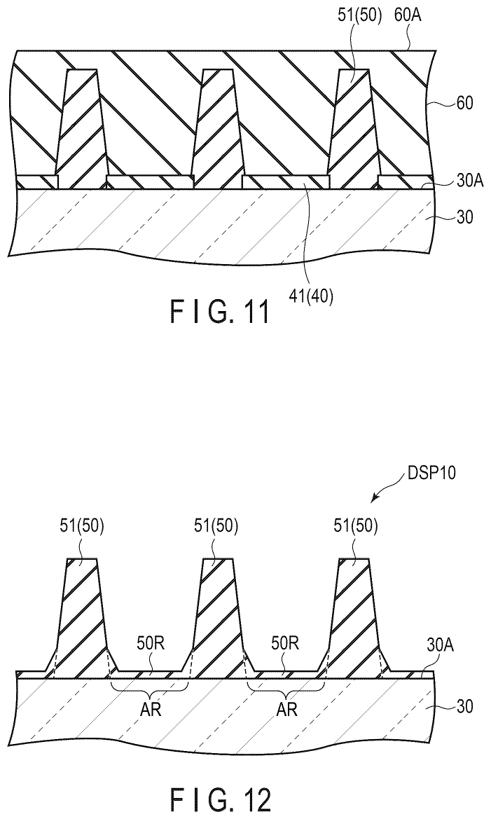

Next, as shown in FIG. 11, a protective layer 60 is formed to cover the transparent layer 40 and the low-refractive index layer 50. Thus, the light guide is completed. Then, the protective layer 60 and the display panel PNL are adhered together using an adhesive layer AD1. Through the manufacturing process including the above-described steps, the display device DSP comprising the transparent layer 40, the low-refractive index layer 50, and the protective layer 60 is manufactured.

FIG. 12 is a diagram illustrating the method of manufacturing the display device DSP 10 according to a comparative example. The display device DSP 10 does not include the transparent layer 40 of the present embodiment. That is, in the manufacturing process of the display device DSP 10, the low-refractive-index material 50M is directly disposed on the entire main surface 30A in the display area DA.

In such a case, as shown in FIG. 12, the low-refractive-index material 50M may remain on the main surface 30A in areas AR each formed between each respective adjacent pair of first portions 51. Hereinafter, the remaining low-refractive-index material 50M is referred to as a residual portion 50R. When the low-refractive-index material 50M contains scattering components (for example, scattering fillers), the material is more likely to have high adhesion to the main surface 30A, and therefore the residual portion 50R particularly is likely to be generated.

With the residual portion 50R described above, it becomes difficult to obtain a low-refractive index layer 50 with a desired shape. The residual portion 50R may become obstructions to the light entering the display panel PNL side between each adjacent pair of first portions 51. As a result, the light-forward-guiding effect of the low-refractive index layer 50 is not sufficiently exhibited, making it difficult to suppress the occurrence of non-uniformity of brightness in the first direction X.

In this embodiment, as shown in FIG. 10, the transparent layer 40 is preformed between each adjacent pair of first portions 51. The transparent layer 40 has an oil repellency higher than that of the main surface 30A of the transparent substrate 30, for example, with respect to the low-refractive index layer 50.

In other words, the adhesion of the disposed low-refractive-index material 50M to the transparent layer 40 is lower as compared to the adhesion to the main surface 30A. Therefore, during the patterning step (shown in FIG. 10), the low-refractive-index material 50M placed on the transparent layer 40 is easier to remove as compared to the low-refractive index material 50M in contact with the main surface 30A.

With this operation, the low-refractive index material 50M can be reliably removed from the desired area where it should be removed, and thus the low-refractive index layer 50 having the desired shape can be formed. Thus, the light-forward-guiding effect of the low-refractive index layer 50 can be fully exhibited, thereby making it possible to appropriately adjust the amount of light entering the display panel PNL side. Therefore, the brightness can be made uniform in the display area DA and thus the degradation of the display quality can be suppressed.

The shape of the first portions 51 is not limited to the shape specified in this embodiment, but it may as well be some other shape. The display device DSP can adjust the amount of light entering the display panel PNL side by, for example, changing the shape, size, and the like of the first portions 51.

Note that in the region close to the light-emitting element LS, light is not completely prohibited from entering the display panel PNL, light can enter the display panel PNL from the transparent layer 40. The side surface 30D is covered, for example, by a reflective material not shown in the figure.

With the above-described configuration, the light reaching the side surface 30D is scattered and reflected by the reflective material, and proceeds through the inside of the transparent substrate 30 in a direction opposite to the first direction X. With the reflective material thus provided, light leakage from the side surface 30D to the outside can be suppressed, and the light can be reused, thereby making it possible to improve the light utilization efficiency.

The light having entered the liquid crystal layer LC while no voltage is being applied thereto, passes through the liquid crystal layer LC without being substantially scattered. On the other hand, the light having entered the liquid crystal layer LC when voltage is being applied thereto is scattered within the liquid crystal layer LC. With the display device DSP having the above-described configuration, it is possible to observe images from the transparent substrate 30 side and also possible to observe images from the transparent substrate 10 side as well.

The display device DSP is a so-called transparent display, and even when the display device DSP is observed from the transparent substrate 30 side, or observed from the transparent substrate 10 side, the background of the display device DSP can be observed through the display device DSP.

With the method of manufacturing the display device DSP, configured as described above, and the display device DSP manufactured by this manufacturing method, it is possible to suppress deterioration in display quality.

Subsequently, other embodiments will be described. Unless otherwise referred to, similar parts of the configuration in the first embodiment can be apply to the following embodiments as well.

### Second Embodiment

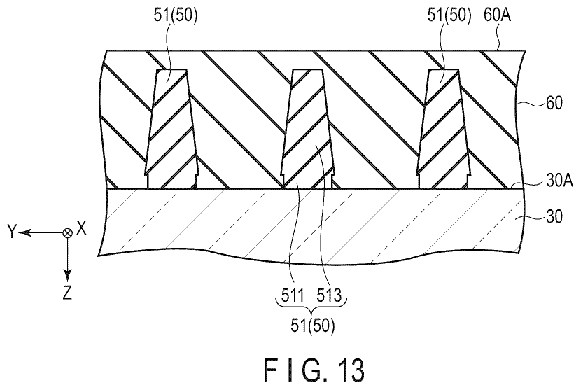

FIG. 13 is a schematic cross-sectional view of a display device DSP according to this embodiment. This embodiment is different from the first embodiment in that it does not comprise the transparent layer 40. In this embodiment, after the step of forming the low-refractive index layer 50 (shown in FIG. 10), the transparent layer 40 is removed in the step shown in FIG. 13, and then the protective layer 60 is formed.

The protective layer 60 covers the low-refractive index layer 50 and the main surface 30A of the transparent substrate 30, as shown in FIG. 13. In other words, the protective layer 60 is in contact with the main surface 30A between each adjacent pair of first portions 51.

When focusing on the low-refractive index layers 50, the low-refractive index layers 50 each have a bottom portion 511 and an upper portion 513. The bottom portion 511 is located between the respective portions of protective layer 60 along the second direction Y. From another perspective, a part of the protective layer 60 is located between each adjacent pair of bottom portions 511.

With the configuration of this embodiment, advantageous effects similar to those of the first embodiment can be obtained.

### Third Embodiment

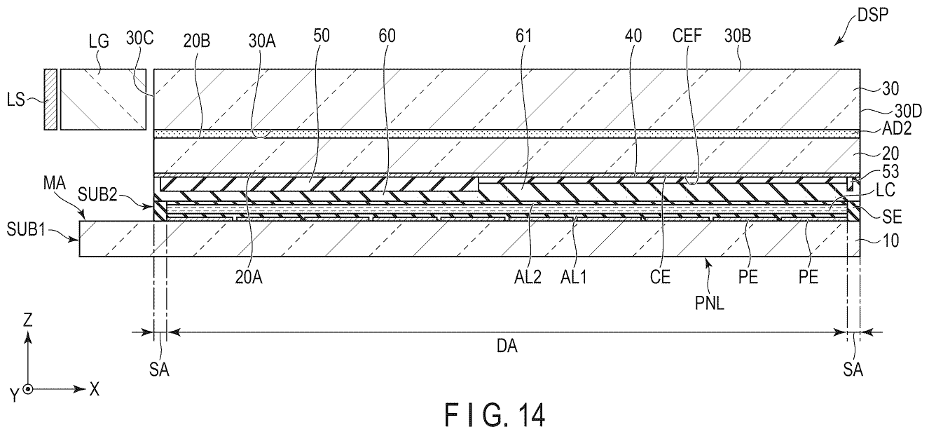

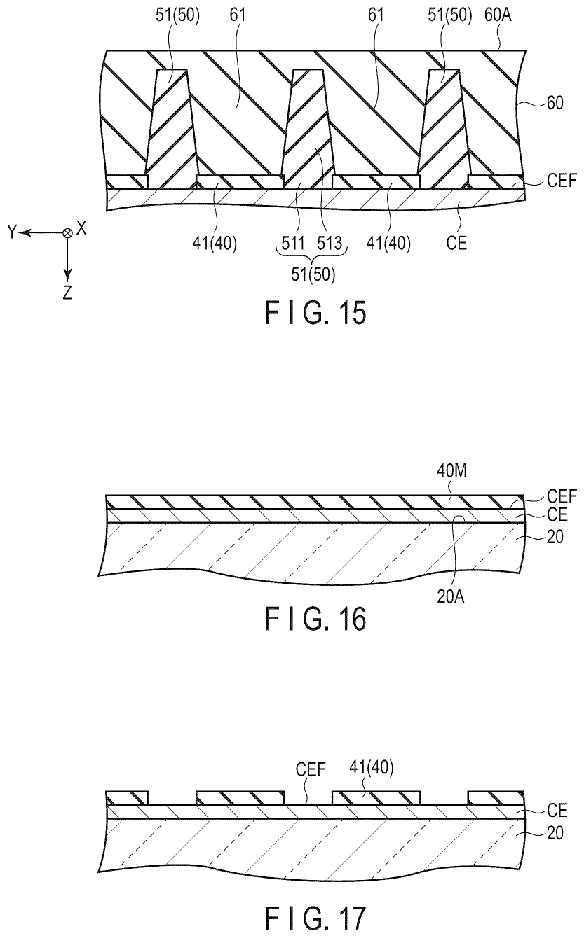

FIGS. 14 and 15 are schematic cross-sectional views of a display device DSP according to this embodiment. This embodiment is different from the first embodiment in the positions where the transparent layer 40, the low-refractive index layer 50, and the protective layer 60 are formed.

The common electrode CE has a main surface CEF, as shown in FIGS. 14 and 15. In this embodiment, the main surface 20A of the transparent substrate 20 is an example of the second main surface, and the main surface CEF is an example of the third main surface.

The common electrode CE is disposed on the main surface 20A. The main surface CEF faces the transparent substrate 10.

The transparent layer 40 and the low-refractive index layer 50 are disposed on the main surface CEF of the common electrode CE. From the perspective of refractive index, the refractive index of the common electrode CE is equivalent to those of the transparent substrate 20, the transparent layer 40, and the like. The refractive index of the low-refractive index layer 50 is lower than that of the common electrode CE.

The transparent layer 40 has an oil repellency higher than that of the main surface CEF of the common electrode CE, for example, with relative to the low-refractive index layer 50. The shapes of the transparent layer 40 and the low-refractive index layer 50 are the same as those of the first embodiment.

The protective layer 60 covers both the transparent layer 40 and the low-refractive index layer 50 from the display panel PNL side, as shown in FIG. 14. The main surface CEF of the common electrode CE is not exposed from the protective layer 60. The alignment film AL2 is located between the protective layer 60 and the liquid crystal layer LC.

In this embodiment, the transparent layer 40, the low-refractive index layer 50, and the protective layer 60 are disposed between the transparent substrate 10 and the transparent substrate 20. The adhesive layer AD2 adheres the main surface 20B of the transparent substrate 20 and the main surface 30A of the transparent substrate 30 to each other.

Next, an example of the method of manufacturing the display device DSP will be described. FIGS. 16 to 20 are diagrams illustrating the method of manufacturing the display device DSP according to this embodiment.

First, the transparent substrate 20 having the main surface 20A is provided as shown in FIG. 16, and the common electrode CE is formed on the main surface 20A. Next, a transparent material 40M is placed on the main surface CEF of the common electrode CE. In one example, the transparent material 40M is applied directly onto the main surface CEF.

Subsequently, as shown in FIG. 17, the transparent material 40M is patterned to form the transparent layer 40. The transparent layer 40 has a shape similar to that of the first embodiment. In this case, at least a part of the main surface CEF of the common electrode CE is exposed. More specifically, the main surface CEF is exposed between each adjacent pair of strip-like portions 41 of the transparent layer 40.

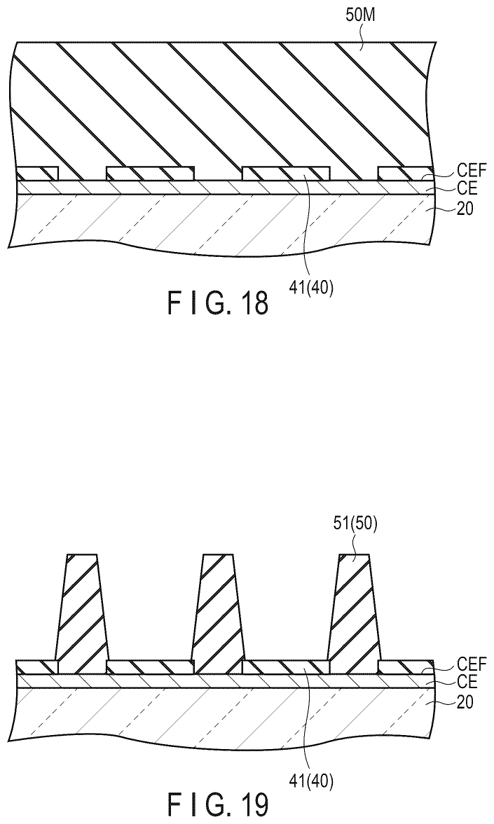

Then, as shown in FIG. 18, a low-refractive index material 50M is placed on the main surface CEF of the common electrode CE and the transparent layer 40. The low-refractive-index material 50M covers the main surface CEF and the transparent layer 40. The thickness of the low-refractive-index material 50M is, for example, greater than the thickness of the transparent layer 40. The low-refractive index material 50M is in contact with each of the main surface CEF of the common electrode CE and the transparent layer 40.

Next, as shown in FIG. 19, the low-refractive-index material 50M is patterned to form the low-refractive index layer 50. The low-refractive index layer 50 has a shape similar to that of the first embodiment, for example.

In the region of the low-refractive index material 50M, which overlaps the transparent layer 40, most of the low-refractive index material 50M is removed (peeled off). In other words, the transparent layer 40 is exposed between each adjacent pair of first portions 51. The exposed portions correspond respectively to the strip-like portions 41 of the transparent layer 40.

The transparent layer 40 has, for example, an oil repellency higher than that of the main surface CEF of the common electrode CE, for example, with relative to the low-refractive index layer 50. In other words, the adhesion of the disposed low-refractive index material 50M to the transparent layer 40 is lower than the adhesion to the main surface CEF. Therefore, during the patterning step (shown in FIG. 19), the low-refractive index material 50M placed on the transparent layer 40 is easier to remove compared to the low-refractive index material 50M in contact with the main surface CEF.

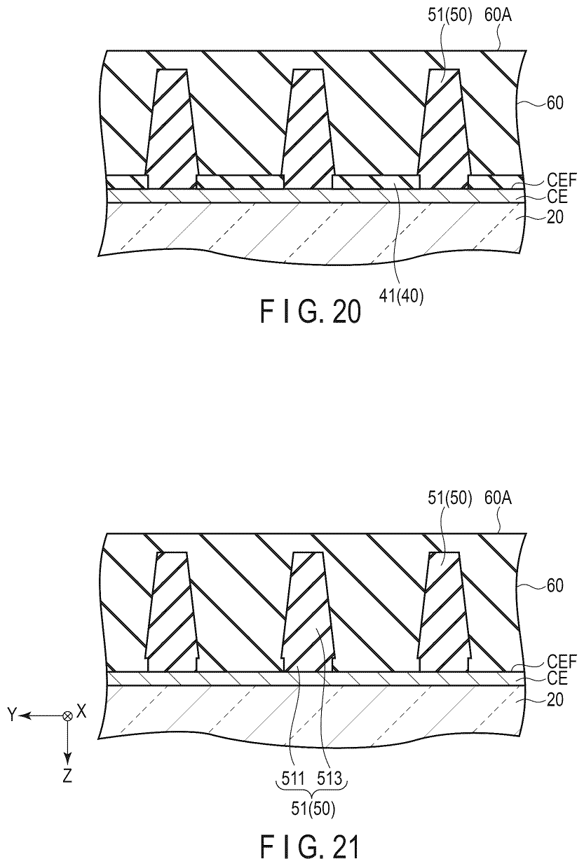

Next, as shown in FIG. 20, the protective layer 60 is formed to cover the transparent layer 40 and the low-refractive index layer 50. Then, the alignment film AL2 is formed on the main surface 60A of the protective layer 60, and thus the second substrate SUB2 is formed. Through the manufacturing process including the steps described above, the display device DSP comprising the transparent layer 40, the low-refractive index layer 50, and the protective layer 60 is manufactured.

With the configuration of this embodiment, advantageous effects similar to those of the first embodiment can be obtained.

### Fourth Embodiment

FIG. 21 is a schematic cross-sectional view of a display device DSP according to this embodiment. This embodiment is different from the third embodiment in that it does not comprise the transparent layer 40. In this embodiment, after the step of forming the low-refractive index layer 50 (shown in FIG. 19), the transparent layer 40 is removed in the step shown in FIG. 21, and thus the protective layer 60 is formed.

The protective layer 60 covers the low-refractive index layer 50 and the main surface CEF of the common electrode CE, as shown in FIG. 21. In other words, the protective layer 60 is in contact with the main surface CEF between each adjacent pair of first portions 51.

Focusing on the low-refractive index layer 50, the low-refractive index layer 50 has a bottom portion 511 and an upper portion 513. The bottom portion 511 is located between respective portions of the protective layer 60 along the second direction Y. From another perspective, a part of the protective layer 60 is located between each adjacent pair of bottom portions 511.

In the configuration of this embodiment, advantageous effects similar to those of the third embodiment can be obtained. In the third embodiment described above and this embodiment, the positions where the transparent layer 40 and the low-refractive index layer 50 are formed are not limited to those of the above-described example. The transparent layer 40 and the low refractive index layer 50 may as well be formed on the main surface 20A of the transparent substrate 20. In this case, a common electrode CE is disposed on the protective layer 60 which covers the transparent layer 40 and the low-refractive index layer 50.

In each of the above-provided embodiments, a light source unit may further be provided. The light source unit irradiates light toward the side surface 30D, for example. In such a case, the shape of the strip-like portions 41 of the transparent layer 40 and the first portions 51 of the low-refractive index layer 50 may as well be appropriately modified.

The display device DSP may further comprise a transparent cover member overlaid on the transparent substrate 10 from the opposite side of the transparent substrate 30. In other words, the display panel PNL may be interposed between the transparent substrate 30 and the cover member. The cover member is an insulating substrate such as a glass substrate or a plastic substrate.

Based on the methods of manufacturing a display device, and manufacturing devices, described above as embodiments of the invention, a person having ordinary skill in the art may achieve manufacturing methods with arbitral design changes; however, as long as they fall within the scope and spirit of the present invention, all of such manufacturing methods are encompassed by the scope of the present invention. A skilled person would conceive various changes and modifications of the present invention within the scope of the technical concept of the invention, and naturally, such changes and modifications are encompassed by the scope of the present invention. For example, if a skilled person adds/deletes/alters a structural element or design to/from/in the above-described embodiments, or adds/deletes/alters a step or a condition to/from/in the above-described embodiment, as long as they fall within the scope and spirit of the present invention, such addition, deletion, and altercation are encompassed by the scope of the present invention.

Furthermore, regarding the present embodiments, any advantage and effect those will be obvious from the description of the specification or arbitrarily conceived by a skilled person are naturally considered achievable by the present invention.

What is claimed is:

1. A method of manufacturing a display device having a liquid crystal layer containing a polymer-dispersed liquid crystal, which can switch between a state in which light entering the liquid crystal layer is transmitted and a state in which the light is scattered according to an applied voltage, the method comprising:
placing a transparent substrate having a first main surface;
placing a transparent material above the first main surface;
forming a transparent layer, in which at least a part of the first main surface is exposed, by patterning the transparent material thus placed;
placing a low-refractive-index material on the first main surface and the transparent layer; and
forming a low-refractive index layer to which the transparent layer is exposed, by patterning the low-refractive index material thus placed,
wherein
the low-refractive index layer has a refractive index lower than that of the transparent substrate, and
the transparent layer has an oil repellency higher than that of the first main surface with respect to the low-refractive index layer.

2. A method of manufacturing a display device having a liquid crystal layer containing a polymer-dispersed liquid crystal, which can switch between a state in which light entering the liquid crystal layer is transmitted and a state in which the light is scattered according to an applied voltage, the method comprising:
placing a transparent substrate having a second main surface;
forming a common electrode having a third main surface on the second main surface;
placing a transparent material on the third main surface;
forming a transparent layer, in which at least a part of the third main surface is exposed, by patterning the transparent material thus placed;
placing a low-refractive-index material on the third main surface and the transparent layer; and
forming a low-refractive index layer to which the transparent layer is exposed, by patterning the low-refractive index material thus placed,
wherein
the low-refractive index layer has a refractive index lower than that of the transparent substrate, and the transparent layer has an oil repellency higher than that of the third main surface with respect to the low-refractive index layer.

3. The method of claim 1, further comprising:
forming a protective layer which covers the transparent layer and the low-refractive index layer,
wherein
the protective layer has a refractive index equivalent to that of the transparent substrate.

4. The method of claim 1, further comprising:
removing the transparent layer after forming the low-refractive index layer.

5. The method of claim 4, further comprising:
forming a protective layer which covers the first main surface and the low-refractive index layer,
wherein
the protective layer has a refractive index equivalent to that of the transparent substrate.

6. The method of claim 2, further comprising:
removing the transparent layer after forming the low-refractive index layer.

7. The method of claim 6, further comprising:
forming a protective layer which covers the third main surface and the low-refractive index layer, wherein
the protective layer has a refractive index equivalent to that of the transparent substrate.

8. The method of claim 1, wherein
a thickness of the low-refractive index layer is greater than a thickness of the transparent layer.

9. A display device comprising:
a first transparent substrate;
a second transparent substrate;
a liquid crystal layer containing a polymer-dispersed liquid crystal and disposed between the first transparent substrate and the second transparent substrate; and
a low-refractive index layer disposed between the liquid crystal layer and the second transparent substrate and having a refractive index lower than that of the second transparent substrate,
wherein
the low-refractive index layer has a bottom portion located on a side of the second transparent substrate and an upper portion having a width greater than that of the bottom portion.

10. The display device of claim 9, further comprising:
a third transparent substrate disposed between the liquid crystal layer and the second transparent substrate,
wherein
the second transparent substrate has a first main surface facing the third transparent substrate, and
the low refractive index layer is disposed on the first main surface.

11. The display device of claim 10, further comprising:
a transparent layer disposed on the first main surface and having a refractive index equivalent to that of the third transparent substrate,
wherein
the transparent layer includes a plurality of strip-like portions extending along a first direction and aligned along a second direction perpendicular to the first direction,
the low-refractive index layer includes portions each disposed between each respective pair of the strip-like portions adjacent to each other along the second direction, and
the transparent layer has an oil repellency higher than that of the first main surface with respect to the low-refractive index layer.

12. The display device of claim 9, further comprising:
a third transparent substrate disposed between the liquid crystal layer and the second transparent substrate and having a second main surface facing the first transparent substrate; and
a common electrode disposed on the second main surface,
wherein
the common electrode has a third main surface facing the first transparent substrate, and
the low-refractive index layer is disposed on the third main surface.

13. The display device of claim 12, further comprising:
a transparent layer disposed on the third main surface and having a refractive index equivalent to those of the third transparent substrate and the common electrode,
wherein
the transparent layer includes a plurality of strip-like portions extending along a first direction and aligned along a second direction perpendicular to the first direction,
the low-refractive index layer includes portions each disposed between each respective pair of strip-like portions adjacent to each other along the second direction, and
the transparent layer has an oil repellency higher than that of the third main surface with respect to the low-refractive index layer.

14. The display device of claim 10, further comprising:
a protective layer which covers the first main surface and the low-refractive index layer, wherein
the protective layer has a refractive index equivalent to that of the second transparent substrate.

15. The display device of claim 11, further comprising:
a protective layer which covers the transparent layer and the low-refractive index layer,
wherein
the protective layer has a refractive index equivalent to that of the second transparent substrate.

16. The display device of claim 12, further comprising:
a protective layer which covers the third main surface and the low-refractive index layer,
wherein
the protective layer has a refractive index equivalent to that of the third transparent substrate.

17. The display device of claim 13, further comprising:
a protective layer which covers the transparent layer and the low-refractive index layer,
wherein
the protective layer has a refractive index equivalent to that of the third transparent substrate.

18. The display device of claim 14, wherein
the protective layer is disposed between each adjacent pair of bottom portions.
